(19) United States
(12) Patent Application Publication
(10) Pub. No.: US 2025/0048282 A1
(43) Pub. Date: Feb. 6, 2025

(54) Power Control Method, Terminal, and Network-Side Device

(71) Applicant: VIVO MOBILE COMMUNICATION CO., LTD., Dongguan (CN)

(72) Inventors: Zuolong Ying, Dongguan (CN); Kai Wu, Dongguan (CN); Dongru Li, Dongguan (CN)

(21) Appl. No.: 18/920,240

(22) Filed: Oct. 18, 2024

Related U.S. Application Data
(63) Continuation of application No. PCT/CN2023/089258, filed on Apr. 19, 2023.

(30) Foreign Application Priority Data
Apr. 20, 2022 (CN) 202210421009.4

(51) Int. Cl. H04W 52/36; H04W 52/14; H04W 52/24

(52) U.S. Cl. CPC H04W 52/367; H04W 52/14; H04W 52/242

(57) ABSTRACT

A power control method includes determining, by a terminal, a first transmit power of a first signal, where the first signal is a signal used for BSC; and transmitting, by the terminal, the first signal using the first transmit power.

### CROSS-REFERENCE TO RELATED APPLICATIONS

This application is a Bypass Continuation application of International Patent Application No. PCT/CN2023/089258, filed Apr. 19, 2023, and claims priority to Chinese Patent Application No. 202210421009.4, filed Apr. 20, 2022, the disclosures of which are hereby incorporated by reference in their entireties.

### BACKGROUND OF THE INVENTION

### Field of the Invention

This application pertains to the field of communication technologies, and in particular, relates to a power control method, a terminal, and a network-side device.

### Description of Related Art

Backscatter communication (BSC) means that a BSC device uses radio frequency signals from other devices or the environment to perform signal modulation, so as to transmit its own information. The BSC device may be a tag in the conventional RFID or a passive Internet of things Passive-IoT (Internet of Things). The BSC device controls a reflection coefficient Γ of a circuit by adjusting its internal impedance, so as to change amplitude, frequency, and phase of an incident signal and implement signal modulation.

At present, after new terminals are introduced into the BSC system, how power control between the network side, the terminal, and the BSC device is implemented is a problem to be resolved urgently.

### SUMMARY OF THE INVENTION

According to a first aspect, a power control method is provided, applied to a terminal, and the method includes: determining, by a terminal, a first transmit power of a first signal, where the first signal is a signal used for BSC; and transmitting, by the terminal, the first signal using the first transmit power.

According to a second aspect, a power control apparatus is provided, where the apparatus may include a determining module and a transmission module. The determining module is configured to determine a first transmit power of a first signal, where the first signal is a signal used for BSC; and the transmission module is configured to transmit the first signal using the first transmit power determined by the determining module.

According to a third aspect, a power control method is provided, applied to a network-side device, where the method includes: transmitting, by a network-side device, network indication information to a terminal, where the network indication information indicates a transmit power related parameter of a first signal, the first signal is a signal used for BSC by the terminal, and the network indication information is used by the terminal to determine a first transmit power of the first signal.

According to a fourth aspect, a power control apparatus is provided, including a transmission module, where the transmission module is configured to transmit network indication information to a terminal, where the network indication information indicates a transmit power related parameter of a first signal, the first signal is a signal for BSC by the terminal, and the network indication information is used by the terminal to determine a first transmit power of the first signal.

According to a fifth aspect, a terminal is provided, where the terminal includes a processor and a memory, and a program or instructions executable on the processor are stored in the memory. When the program or the instructions are executed by the processor, the steps of the method according to the first aspect are implemented.

According to a sixth aspect, a terminal is provided, including a processor and a communication interface, where the processor is configured to determine a first transmit power of a first signal, where the first signal is a signal used for BSC; and the communication interface is configured to transmit the first signal using the first transmit power determined by the processor.

According to a seventh aspect, a network-side device is provided, where the network-side device includes a processor and a memory, and a program or instructions executable on the processor are stored in the memory. When the program or the instructions are executed by the processor, the steps of the method according to the third aspect are implemented.

According to an eighth aspect, a network-side device is provided, including a processor and a communication interface, where the communication interface is configured to transmit network indication information to a terminal, where the network indication information indicates a transmit power related parameter of a first signal, the first signal is a signal used for BSC, and the network indication information is used by the terminal to determine a first transmit power of the first signal.

According to a ninth aspect, a communication system is provided, including: a terminal and a network-side device, where the terminal may be configured to perform the steps of the power control method according to the first aspect, and the network-side device may be configured to perform the steps of the power control method according to the third aspect.

According to a tenth aspect, a non-transitory readable storage medium is provided, where a program or instructions are stored in the non-transitory readable storage medium, and when the program or the instructions are executed by a processor, the steps of the method according to the first aspect are implemented, or the steps of the method according to the third aspect are implemented.

According to an eleventh aspect, a chip is provided, where the chip includes a processor and a communication interface, the communication interface is coupled to the processor, and the processor is configured to run a program or instructions to implement the method according to the first aspect or implement the method according to the third aspect.

According to a twelfth aspect, a computer program/program product is provided, where the computer program/program product is stored in a non-transitory storage medium, and the computer program/program product is executed by at least one processor to implement the steps of the power control method according to the first aspect or the steps of the power control method according to the third aspect.

### BRIEF DESCRIPTION OF THE DRAWINGS

FIG. 1 is a schematic architectural diagram of a communication system according to an embodiment of this application;

FIG. 2 is a first schematic flowchart of a power control method according to an embodiment of this application;

FIG. 3 is a schematic flowchart of communication between a terminal, a network-side device, and a receiving terminal in BSC;

FIG. 4 is a schematic diagram of receiving terminals of a first inventory round and a second inventory round;

FIG. 5 is a second schematic flowchart of a power control method according to an embodiment of this application;

FIG. 6 is a first schematic structural diagram of a power control apparatus according to an embodiment of this application;

FIG. 7 is a second schematic structural diagram of a power control apparatus according to an embodiment of this application;

FIG. 8 is a schematic structural diagram of a communication device according to an embodiment of this application; and

FIG. 9 is a schematic structural diagram of a terminal according to an embodiment of this application; and

FIG. 10 is a schematic structural diagram of a network-side device according to an embodiment of this application.

### DESCRIPTION OF THE INVENTION

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

In the specification and claims of this application, the terms such as “first” and “second” are intended to distinguish between similar objects but do not necessarily indicate an order or sequence. It should be understood that the data used in this way is interchangeable in appropriate circumstances so that the embodiments of this application can be implemented in other orders than the order illustrated or described herein, and “first” and “second” are usually for distinguishing same-type objects but not limiting the number of objects, for example, there may be one or more first objects. In addition, “and/or” in this specification and claims indicates at least one of connected objects, and the symbol “/” generally indicates that the contextually associated objects are in an “or” relationship.

It should be noted that techniques described in the embodiments of this application are not limited to a long term evolution (LTE) or LTE-advanced (LTE-A) system, and may also be applied to various wireless communication systems, for example, code division multiple access (CDMA), time division multiple access (TDMA), frequency division multiple access (FDMA), orthogonal frequency division multiple access (OFDMA), single-carrier frequency-division multiple access (SC-FDMA), and other systems. The terms “system” and “network” in the embodiments of this application are usually used interchangeably. Techniques described herein may be used in the aforementioned systems and radio technologies, and may also be used in other systems and radio technologies. In the following descriptions, a new radio (NR) system is described for an illustration purpose, and NR terms are used in most of the following descriptions, although these technologies may also be applied to other applications than an NR system application, for example, the 6th generation (6G) communication system.

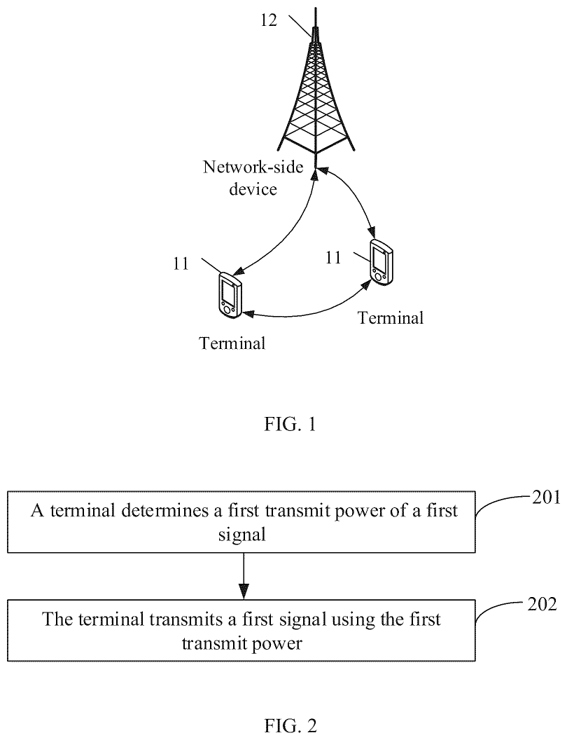

FIG. 1 is a block diagram of a wireless communication system to which the embodiments of this application are applicable. The wireless communication system includes a terminal 11 and a network-side device 12. The terminal 11 may be a terminal-side device, such as a mobile phone, a tablet computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), a smart home device (a home device with wireless communication function, such as a refrigerator, a television, a washing machine, or a furniture), a game console, a personal computer (PC), a teller machine, a self-service machine, or the like. The wearable device includes: a smart watch, a wrist band, smart earphones, smart glasses, smart jewelry (smart bracelet, smart wristband, smart ring, smart necklace, smart anklet, smart ankle bracelet, or the like), smart wristband, smart clothing, and the like. It should be noted that a type of the terminal 11 is not limited in the embodiments of this application. The network-side device 12 may include an access network device or a core network device, where the access network device 12 may also be referred to as a radio access network device, a radio access network (RAN), a radio access network function, or a radio access network unit. The access network device 12 may include a base station, a WLAN access point or a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission and reception point (TRP), or another appropriate term in the art. Provided that a same technical effect is achieved, the base station is not limited to a technical term. It should be noted that in the embodiments of this application, the base station in the NR system is merely used as an example, and a type of the base station is not limited.

With reference to the accompanying drawings, the following describes in detail, by using some embodiments and application scenarios thereof, a power control method and apparatus, a terminal, a network-side device, and a system provided in the embodiments of this application.

The following describes some concepts and/or terms used in a power control method and apparatus, a terminal, a network-side device, and a system provided in the embodiments of this disclosure.

Uplink: A direction of transmission performed by a terminal is uplink, for example, a terminal performs transmission to a base station or a terminal performs transmission to a BSC device.

Downlink: A direction of transmission performed by a base station is downlink, for example, a base station performs transmission to a terminal or abase station performs transmission to a BSC device. It means that the BSC device may be considered as a passive terminal, such as a tag. A direction of transmission performed by a BSC device is also referred to as uplink.

### Backscatter Communication:

Backscatter communication means that a BSC device uses radio frequency signals from other devices or the environment to perform signal modulation, so as to transmit its own information. The BSC device may be a tag in the conventional radio frequency identification (RFID) technology or a passive IoT (Passive Internet of Things). The BSC device controls a reflection coefficient Γ of a circuit by adjusting its internal impedance, so as to change amplitude, frequency, and phase of an incident signal and implement signal modulation. The reflection coefficient of the signal may be represented as:

$$Γ = \frac{{Z}_{1} - {Z}_{0}}{{Z}_{1} + {Z}_{0}} = \vert Γ \vert {e}^{j {θ}_{T}} ;$$

where

Z₀ is an antenna impedance and Z₁ is a load impedance. Assuming that an incident signal is Sᵢₙ(t), an output signal is Sₒᵤₜ(t)=Sᵢₙ(t)Γ|)e^{jθ}^{_{T}}. Therefore, the corresponding amplitude modulation, frequency modulation or phase modulation may be implemented by controlling the reflection coefficient properly.

### Power Control:

In the BSC system, before the user equipment (UE) establishes a connection to a base station (BS), the UE is not controlled by the base station, and the UE adjusts a power through its own parameters, that is, an open-loop power (for example, physical random access channel (PRACH) process). Then, when the UE establishes a connection to the BS, the BS can control the power of the UE, thus forming a control loop. The power control at this stage is called closed-loop power control.

Closed-loop power control: indicates that a transmitting end controls a transmit power according to feedback information sent by a receiving terminal. Open-loop power control: Power control is implemented based on its own measurement, not requiring feedback information from the receiving terminal.

In closed-loop power control, once an initial PRACH is detected, a power of the UE is dynamically controlled by a transmit power control TPC (TPC) command. It means that the transmit power of the UE is controlled by some feedback inputs of the base station. In this way, the whole power control process forms one loop (closed loop).

Downlink control information (DCI)
(1) DCI2_2:

DCI2_2 is a transmit power control (TPC) command for transmitting a physical uplink control channel (PUCCH) and a physical uplink shared channel (PUSCH).

DCI2_2 uses TPC-PUSCH-RNTI or TPC-PUCCH-RNTI for cyclic redundancy check (CRC) scrambling.

DCI2_2 transmits the following information: block number 1, block number 2, . . . , block number N.

The parameter tpc-PUSCH or tpc-PUCCH is provided in a higher-layer parameter, and is used for determining a block number index of uplink (UL) of a cell. For each block, the following (A) and/or (B) is included:

A: Closed loop indicator, where the closed loop indicator may include 0 or 1 bit.
A1: For DCI 2_2 scrambled by TPC-PUSCH-RNTI, if a higher-layer parameter (such as two PUSCH-PC-Adjustment States) is not configured for the UE, that is, the closed-loop indicator includes 0 bit, then the UE assumes that each block in DCI 2_2 includes 2 bits; otherwise the closed-loop indicator includes 1 bit, then the UE assumes that each block in DCI 2_2 includes 3 bits.
A2: For DCI 2_2 scrambled by TPC-PUCCH-RNTI, if a higher-layer parameter twoPUCCH-PC-AdjustmentStates is not configured for the UE, that is, the closed-loop indicator includes 0 bits, then in this scenario, the UE assumes that each block in DCI 2_2 includes 2 bits; otherwise the closed-loop indicator includes 1 bit, then in this scenario, the UE assumes that each block in DCI 2_2 includes 3 bits.

B: TPC command, where the TPC command can include 2 bits.
(2) DCI 2_3:

DCI format 2-3 is used for transmitting a channel sounding reference signal SRS (SRS) TPC command for one group of UEs. In addition to the SRS TPC command, an SRS request may alternatively be transmitted. DCI 2_3 uses TPC-SRS-RNTI for CRC scrambling.

Table 1 below provides examples of DCI formats and corresponding transmission commands.

TABLE 1
Examples of DCI formats and corresponding
transmission commands

| DCI | |
|---|---|
| format | Usage |
| 2_2 | Transmitting a TPC command |
| | for PUCCH and PUSCH. |
| 2_3 | Transmitting a group of TPC |
| | commands for SRS transmission |
| | through one or more UEs. |

Inventory round: A time period between two same-type inventory commands sent by a terminal (reader/writer or inquirer) is referred to as an inventory round.

The inventory command may include any signal with an inventory function for a target: query signal, repeated query signal, reply signal, read signal, write signal, and random request signal.

The following describes an inventory round with examples.

For example, using the inventory command being a query signal as an example, one inventory round may be a time period between the i-th query signal and the (i+1)-th query signal sent by the terminal. It can be understood that after transmitting the i-th query signal and before transmitting the (i+1)-th query signal, the terminal can also transmit several other types of inventory commands, such as several repeated query signals.

For another example, using the inventory command being a repeated query signal as an example, one inventory round is a time period between the j-th repeated query signal and the (j+1)-th repeated query signal sent by the terminal.

An embodiment of this application provides a power control method. FIG. 2 is a possible schematic flowchart of the power control method provided in this embodiment of this application. As shown in FIG. 2, the power control method provided in this embodiment of this application may include the following steps 201 and 202.

Step 201: The terminal determines a first transmit power of a first signal.

Step 202: The terminal transmits a first signal using the first transmit power.

The first signal is a signal used for BSC.

Optionally, in this embodiment of this application, the first signal may include a carrier signal or a control signal.

It can be understood that in this embodiment of this application, the carrier signal is also referred to as an excitation signal.

Optionally, in this embodiment of this application, the control signal may include at least one of the following: a selection signal, a query signal, a repeated query signal, a reply signal, a read signal, a write signal, a random request signal, or the like.

In this embodiment of this application, the first signal is an uplink signal in a BSC system. In the BSC system, after the terminal transmits the first signal, a BSC device (also referred to a receiving terminal) within a transmission range of the first signal, such as a tag, can receive the first signal and modulate the first signal to form a reflected signal, so that the network-side device can receive (or may not receive) the reflected signal. In this way, the communication between the terminal and the network-side device in the BSC system may be implemented.

In this embodiment of this application, a process that the terminal determines the first transmit power of the first signal can also be referred to a power control process for the transmit power of the first signal.

Optionally, in this embodiment of this application, the first transmit power of the first signal may be determined in at least one of the following manners 1 to 5:

Manner 1: being predefined or pre-configured; manner 2: power related information of a downlink signal; manner 3: a second transmit power of an uplink channel or an uplink signal; manner 4: network indication information; and manner 5: a signal type of the first signal.

The following describes manner 1 to manner 5 in detail.
Manner 1: Being predefined or pre-configured

For example, the first transmit power may be pre-configured as a maximum transmit power of the terminal, that is, P_{C,MAX}.

For another example, a transmit power formula of the first signal may be predefined, and through the transmit power formula, the terminal does not need to transmit an indication through the network when establishing connection to the tag, so as to quickly perform tag inventory in a timely manner. The transmit power formula may be: P=P_{UE,MAX} or P_{C,MAX} where P_{UE,MAX} and P_{C,MAX} both refer to the maximum transmit power of the terminal.
Manner 2: Power related information of a downlink signal

It should be noted that the downlink signal is a signal sent by the network side to the terminal through the wireless communication network.

Optionally, in this embodiment of this application, the power-related information of the downlink signal may include at least one of the following: a receive power of the downlink signal or a measured path loss value of the downlink signal.

In this embodiment of this application, the measured path loss value of the downlink signal may be determined based on the receive power of the downlink signal.

In this embodiment of this application, the measured path loss value of the downlink signal can also be referred to the measured path loss value of the downlink signal, which have the same meaning and may be used interchangeably.

Optionally, in this embodiment of this application, the downlink signal includes at least one of the following: a downlink reference signal of a serving cell or a downlink reference signal determined based on a BSC-specific reference resource; and the BSC-specific reference resource is different from a resource of the serving cell.

Optionally, in this embodiment of this application, the serving cell may be a serving cell in an NR network, a serving cell in a 4G network, or a serving cell in a 6G network, which may be determined according to real-time usage requirements.

Optionally, in this embodiment of this application, the BSC-specific reference resource may be a BSC-specific downlink reference resource.

In this embodiment of this application, the downlink reference resource is not a resource of the serving cell, that is, the downlink reference resource is different from the resource of the serving cell. For example, the downlink reference resource is a synchronization signal block (SSB) or a channel state information reference signal (CSI-RS) of a non-legacy NR cell.

It can be understood that when the downlink signal includes a downlink reference signal determined based on the BSC-specific reference resource, the BSC may be considered as a serving cell of the terminal, and a downlink (DL) reference resource for power control is defined for BSC, that is, the BSC-specific downlink reference resource.

Optionally, in this embodiment of this application, the downlink signal may include at least one of the following: SSB or CSI-RS.

For example, in a case that the downlink signal includes a downlink reference signal of the serving cell, the downlink signal may include at least one of SSB or CSI-RS of the serving cell in the NR network.

In a case that the downlink signal includes a downlink reference signal determined based on the BSC-specific reference resource, the downlink signal may include at least one of SSB or CSI-RS determined based on the BSC-specific downlink reference resource, for example, the downlink signal is at least one of SSB or CSI-RS in the downlink reference resource.

In this embodiment of this application, the first transmit power is determined based on the downlink reference signal of the serving cell, that is, an existing reference channel or signal resource is used, thereby reducing overheads. Determining the first transmit power of the first signal based on the downlink reference signal that is determined based on the BSC-specific reference resource can improve accuracy of the first transmit power.

Optionally, in this embodiment of this application, the BSC-specific reference resource may be determined based on a beacon corresponding to a frequency band supported by the BSC, and the beacon is generated through modulation based on a target modulation mode.

The beacon includes at least one of the following: one sequence, time synchronization information, or a cell identifier (Identity Document, ID); and the target modulation mode may include at least one of the following: amplitude keying ASK, on-off keying OOK, or phase shift keying PSK.

In this embodiment of this application, the beacon may correspond to the transmit power of the first signal, for example, one sequence may indicate the terminal to transmit the first signal based on a P power.

Optionally, in this embodiment of this application, the cell identifier is a cell identifier of the BSC when the BSC is considered as a serving cell of the terminal, and the cell identifier may be compared with a cell ID in the NR network.
Manner 3: Second transmit power of an uplink channel or an uplink signal

In this embodiment of this application, the uplink channel may also be referred to an uplink reference channel, which have the same meaning and may be used interchangeably. Correspondingly, the uplink signal may also be referred to an uplink reference signal, which have the same meaning and may be used interchangeably.

It should be noted that both the uplink channel and the uplink signal are channels and signals in other communication systems than the BSC, for example, the uplink signal and the uplink channel are channels and signals in the NR network respectively.

Optionally, in this embodiment of this application, the uplink channel may include at least one of the following: PUSCH, PUCCH, SRS, or PRACH.

Optionally, when the uplink channel (or uplink reference channel) may be PUSCH, and the uplink channel may be CG-PUSCH.

Optionally, in this embodiment of this application, the first transmit power is determined based on the second transmit power and a power adjustment amount, or the first transmit power is determined based on the second transmit power and a power adjustment factor.

For example, first transmit power=second transmit power+preset power adjustment amount, or first transmit power=second transmit power*preset power adjustment factor.

Optionally, in this embodiment of this application, it is assumed that the preset power adjustment amount is δ1, where δ1 may be positive, negative, or 0. It is assumed that the preset power adjustment factor is α1, where α1 has no unit, and α1>0.

The following describes manner 3 with examples.

For example, the transmit power of the first signal is determined based on the transmit power of the reference channel, such as the PUSCH channel, where PUSCH here is a channel of a link from the terminal to the base station (BS), and a transmit power of the PUSCH channel is calculated as follows:

$${P}_{PUSCH , b , f , c} ( i , j , {q}_{d} , l ) = min \{ \begin{matrix}{P}_{C MAX , f , c} ( i ) , \\ {P}_{O\_PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \}$$

where, a power adjustment amount δ1 is added to the power of P_{PUSCH} to obtain the final first transmit power of the first signal, where δ1 here may be positive, negative, or 0; or the power of P_{PUSCH} is multiplied by the power adjustment factor al to obtain the first transmit power of the final first signal, where α1>0.

In this way, because the first transmit power of the first signal may be determined based on the transmit power of the uplink signal or the uplink channel, that is, the transmit power of the signal in the BSC system may be determined by multiplexing an existing signal or channel resource, thus reducing overheads of the terminal.
Manner 4: Network indication information

The network indication information may indicate a transmit power related parameter of the first signal.

Optionally, in this embodiment of this application, the network indication information may be acknowledgement (ACK) or non-acknowledgement NACK information of the network-side device; or the network indication information may be 1 or 0 in 1-bit information. The network indication information is ACK information or 1, that is, the network-side device receives reception feedback information of the receiving terminal, and the network indication information is NACK information or 0, that is, the network-side device does not receive a feedback from the receiving terminal.

Optionally, in this embodiment of this application, in a case that the network indication information includes information determined based on a reception feedback status, each piece of network indication information may indicate a reception feedback status of at least one receiving terminal for the second signal. This can improve flexibility of indicating the reception feedback status of the receiving terminal for the second signal.

Optionally, in this embodiment of this application, the network indication information includes one of the following manners a to c:
Manner a: Semi-static configuration information

Optionally, in this embodiment of this application, when the network indication information is semi-static configuration information, the first transmit power is a power configured based on the semi-static configuration information.
Manner b: TPC information

In this embodiment of this application, according to a closed-loop power control principle, the power of the terminal is dynamically controlled by TPC information.

Optionally, in this embodiment of this application, the TPC information may indicate a transmit power adjustment amount of the first signal. In other words, the TPC information indicates a change amount of the uplink transmit power of the first signal.

For example, the first transmit power of the first signal transmitted by the terminal in the latest time is P1, and the transmit power adjustment amount indicated by TPC information is δ2. In this case, the first transmit power of the first signal to be transmitted by the terminal this time is P1+δ2, where δ2 is a rational number, that is, δ2 may be positive, negative, or 0.

Optionally, in this embodiment of this application, the TPC information may also indicate a target power control process of the terminal transmitting the first signal, where the target power control process may include one of the following: an independently configured power control process and a same power control process as a target channel.

For example, when the target power control process includes the same power control process as the target channel, the target power control process may be a same power control process as the power control process of PUSCH or PUCCH.

In this way, in a case that the network indication information includes TPC information, because the network indication information can indicate that the target power control process of the terminal transmitting the first signal is an independent power control process or the same power control process as the target channel, the flexibility of configuring the target power control process of the terminal transmitting the first signal can be improved.
Manner c: Information determined by the network-side device based on the reception feedback status of the receiving terminal for the second signal

The second signal is a signal for BSC that has been sent by the terminal. For example, the second signal is the first signal recently sent by the terminal, or the second signal is a signal recently sent by the terminal and having a same signal type as the first signal for BSC currently to be sent by the terminal.

Optionally, in this embodiment of this application, the reception feedback status of the receiving terminal for the second signal may include at least one of the following: whether the receiving terminal receives the second signal, whether the receiving terminal transmits reception feedback information, or whether the reception feedback information includes adjustment information for adjusting the transmit power of the first signal; where the reception feedback information is feedback information of the receiving terminal on whether the second signal is received.

Optionally, the receiving terminal in this embodiment of this application may be a BSC device, for example, the BSC device may be a tag in RFID; or the BSC device may be a passive Passive-IoT.

It should be noted that the number of receiving terminals is not limited in this embodiment of this application, that is, the number of receiving terminals may be one or more.

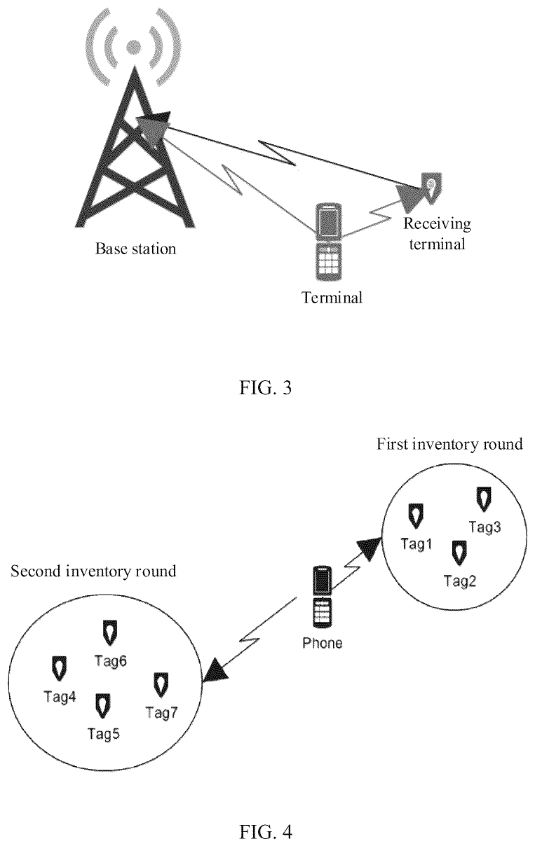

Optionally, in this embodiment of this application, in the above manner c, the communication flow between the terminal, the network-side device, and the receiving terminal is shown in FIG. 3. As shown in FIG. 3, the terminal transmits a continuous wave or a command to the receiving terminal (a tag), and the tag can modulate the signal and reflect the modulated signal. The base station (that is, the network-side device) may receive (may fail to receive) the reflected signal from the tag, and then the base station indicates the terminal to adjust the transmit power of the signal for BSC, where the transmit power is a transmit power from the terminal to the tag.

Optionally, in this embodiment of this application, in a case that the network indication information includes information that is determined by the network-side device based on the reception feedback status of the receiving terminal for the second signal, the network indication information may indicate at least one of the following: a transmit power adjustment policy of the first signal (the first manner) or the reception feedback status of the receiving terminal for the second signal (the second manner).

In this embodiment of this application, after receiving the second signal, the receiving terminal may transmit reception feedback information indicating that it has received the second signal; or, if the receiving terminal does not receive the second information within a preset duration, the receiving terminal may transmit reception feedback information indicating that it has not received the second signal, or the receiving terminal device does not transmit the reception feedback information. After the receiving terminal device transmits the reception feedback information, the network device may receive the reception feedback information; certainly, in actual implementation, the network-side device may fail to receive the reception feedback information.

It can be understood that for the network-side device, the network-side device may determine whether the terminal receives the second signal, based on at least one of the following: whether the reception feedback information is received, the reception feedback information, or whether a reflected signal of the terminal on the second signal (that is, the signal modulated by the terminal on the second signal) is received.

If the network-side device receives no reception feedback information or the reflected signal of the terminal for the second signal, and/or receives the reception feedback information indicating that the terminal receives no second signal, the network-side device determines that the terminal has not received the second signal.

If the network-side device receives the reception feedback information indicating that the terminal has received the second signal, and/or receives a reflected signal of the terminal for the second signal, the network-side device determines that the terminal receives the second signal.

For example, using whether the network-side device receives the reflected signal of the terminal for the second signal as an example, the network-side device adjusts the transmit power of the first signal based on whether the reflected signal of the tag is received. When the terminal performs tag inventory, a tag close forms a reflected signal, and a tag far away may not form a reflected signal, so the network may receive all or part or no reflected signal of the tags. In this case, the network side delivers network indication information to indicate the terminal, telling the terminal whether the network-side device has received the feedback information of the tags, and/or indicating whether the terminal needs to adjust the transmit power of the first signal. For example, the network-side device may use acknowledgement information ACK/non-acknowledgement information NACK for indication. If the network indication is ACK, it indicates that the network has received the feedback from the tag, and the power of the terminal may remain unchanged. For example, the power of the terminal may be gradually reduced, and if the network indication information is one or more NACKs, the transmit power may be gradually increased based on a step. For example, feedback statuses of multiple tags may be indicated to the terminal using same network indication information.

It should be noted that in the second manner, the network indication information includes information that is determined based on the reception feedback status of the receiving terminal for the second signal, and the information indicating the reception feedback status is carried in the network indication information and sent to the terminal.

Optionally, in this embodiment of this application, it is assumed that the network indication information indicates the transmit power adjustment policy of the first signal, that is, in the first manner, then:
in a case that the receiving terminal receives the second signal, the transmit power adjustment policy of the first signal is: not adjusting the transmit power of the first signal, or reducing the transmit power of the first signal, for example, gradually reducing the transmit power of the first signal based on a first step; or
in a case that the receiving terminal receives no second signal, the transmit power adjustment policy of the first signal is: increasing the transmit power of the first signal, for example, gradually increasing the transmit power of the first signal based on a second step; or
in a case that the reception feedback information includes the transmit power adjustment information, the transmit power adjustment policy of the first signal is: a power adjustment policy indicated by the transmit power adjustment information.

For example, if the tag receives the second signal and feeds it back to the network-side device, it means that the power of the terminal for transmitting the second signal is relatively high, so the network indication information is used to indicate that the transmit power of the first signal of the terminal remains unchanged (that is, indicating that the first signal is transmitted at the transmit power of the second signal). For example, the transmit power of the first signal is gradually reduced based on a certain step, so that the power consumption of the terminal for transmitting the first signal may be reduced.

For another example, if the tag receives no second signal and there is no feedback, it means that the transmit power of the terminal for transmitting the second signal is small, so the network indication information may be used to indicate the terminal to increase the transmit power based on a certain step.

Optionally, in this embodiment of this application, in the above second manner, the terminal may determine the first transmit power according to the indication of the network indication information. The first transmit power determined by the terminal may alternatively be a power adjustment policy of the first transmit power.

It can be understood that the power adjustment policy determined by the terminal may be the same as the power adjustment policy in the first manner when the reception feedback status of the second signal by the terminal is the same.
Manner 5: Signal type of the first signal

Optionally, in this embodiment of this application, when the first transmit power is determined based on the signal type of the first signal, the step 201 may be implemented through the following step 201a or step 201b.

Step 201a: The terminal determines a transmit power corresponding to the signal type as the first transmit power based on the signal type of the first signal.

In this embodiment of this application, first signals of different signal types may be associated with different transmit powers.

For example, a transmit power corresponding to a query signal is X dB; and a transmit power corresponding to a repeated query signal is (X+Δx) dB, where Δx is a rational number.

Step 201b: The terminal adjusts a transmit power of a third signal based on the signal type of the first signal, and determines an adjusted transmit power as the first transmit power, where the third signal is a signal for the BSC that has been sent by the terminal.

For example, a signal type of a signal for BSC (that is, a third signal) transmitted by the terminal recently is a query signal, and a transmit power of the query signal is X dB. Then, when the terminal transmits a repeated query signal (that is, the first signal to be transmitted), the terminal can determine that the transmit power of the repeated query signal is (X+Δx) dB (that is, the first transmit power), so that the terminal can transmit the repeated query signal at (X+Δx) dB.

For example, Δx may be a transmit power difference between the query signal and the repeated query signal (the transmit power difference may be predefined or pre-configured).

Optionally, in this embodiment of this application, the terminal may alternatively determine the transmit power (for example, the first transmit power) of the first signal to be transmitted, based on the signal type of the first signal and response information of the third signal.

For example, assuming that the transmit power of the terminal for transmitting the query signal is X dB and the transmit power of the terminal for transmitting the repeated query signal is (X+Δx) dB, if the terminal needs to transmit a carrier signal for BSC, then: if response information corresponding to the repeated query signal indicates that no new receiving terminal is found based on the repeated query signal, it means that all receiving terminals may be found by transmitting the first signal at X dB. Therefore, the terminal may determine that a transmit power of a subsequent carrier signal (that is, the first signal) may be the same as the transmit power (X+Δx) dB of the repeated query signal, or may adjust the transmit power of the subsequent carrier signal to the transmit power X dB of the query signal; or if the response information corresponding to the repeated query signal indicates that a new receiving terminal is found based on the repeated query signal, it means that the signal for BSC transmitted at X dB cannot cover all receiving terminals, and the terminal may determine that the transmit power of the subsequent carrier signal is X dB, that is, being the same as the transmit power of the repeated query signal.

The following describes the power control method provided in this embodiment of this application with reference to the examples.

Example 1: Different signal types are associated with different power adjustment amounts δ0. For example, when the first signal is a query signal, δ0 is X dB, and when the first signal is a repeated query signal, δ0 is adjusted to (X+Δx) dB to expand a querying range. If no new tag is found in the process of repeated querying, it means that all tags have been inventoried for the transmit power X dB of the first signal, and the transmit power of the subsequent carrier signal may be readjusted to X dB. It may be alternatively possible that one or more tags are far away, and tags have not been inventoried yet even for the transmit power (X+Δx) dB of the first signal. In this case, it depends on whether the repeated query signal is sent again to continue increasing the transmit power of the first signal, and in addition, the transmit power of the first signal does not need to exceed the maximum transmit power allowed by the terminal.

Example 2: The transmit power of the third signal is adjusted based on the signal type of the carrier signal (that is, the first signal), so as to determine the transmit power of the subsequent carrier signal (that is, the first signal) after the third signal is transmitted.

For example, when the third signal is a query signal in a control command, the transmit power of the third signal is X dB; then during repeated querying, the transmit power of the repeated query signal (that is, the first signal) is (X+Δx) dB.

For example, if no new tag is found during repeated querying, it means that all tags may have been covered by the signal for BSC transmitted at the transmit power of X dB power. In this case, for transmission of the carrier signal (that is, the first signal), the carrier signal may be transmitted at the transmit power of X dB to cover all tags. In this way, the transmit power of subsequent carrier can be reduced to decrease power consumption.

In this embodiment of this application, because the first transmit power of the first signal may be determined based on the signal type of the first signal, the process of determining the transmit power of the subsequent first signal can be simplified, and accuracy of transmitting the first signal can be improved.

Optionally, in this embodiment of this application, the foregoing step 202 may be implemented by step 202a described below.

Step 202a: The terminal transmits the first signal using the first transmit power within at least one first time period after the first transmit power is determined.

In this embodiment of this application, the at least one first time period is continuous.

Optionally, in this embodiment of this application, the first time period may be a preset time period or the first time period may be one inventory round. For detailed description of the inventory round, refer to the description of the inventory round in the above explanation of terms.

It can be understood that, using the at least one inventory round being one inventory round as an example, the terminal considers by default that distances from all receiving terminals (such as tags) in inventory to the terminal are close, and therefore inventory may be performed by using the same transmit power for all receiving terminals with the same or similar distances from the terminal.

For example, using the receiving terminal being a tag as an example, as shown in FIG. 4, in a first inventory round, the terminal may perform inventory on tags 1-3 with a transmit power 1; and in a second inventory round, the terminal may perform inventory on tags 4-7 with a transmit power 2. Because tags 4-7 are farther away from the terminal than tags 1-3, the network-side device re-indicates the terminal during the second inventory round to transmit the first signal, that is, increase the transmit power. In other words, the transmit power 1 is less than the transmit power 2. In this way, a plurality of power adjustments in a short time can be avoided.

For another example, because distances between the receiving terminals and the terminals in adjacent inventory rounds may have a small difference, inventory of the receiving terminals can be implemented with a same power in two adjacent or continuous inventory rounds.

In this embodiment of this application, because the terminal can transmit the first signal at the first transmit power in at least one first time period after determining the first transmit power, multiple adjustments of the transmit power in a short time may be avoided.

The following describes the power control method provided in this embodiment of this application with reference to the examples.

For example, the transmit power of the first signal may be determined in one of the following four manners: Manner 1: The transmit power formula of the first signal is predefined, and tag inventory may be performed quickly in a timely manner, nor requiring to transmit an indication through the network when the terminal establishes connection to the tag. For example, a transmit power formula of the first signal may be predefined, and through the transmit power formula, the terminal does not need to transmit an indication through the network when establishing connection to the tag, so as to quickly perform tag inventory in a timely manner. The transmit power formula may be: P=P_{UE,MAX} or P_{C,MAX}; where

P_{UE,MAX} and P_{C,MAX} both refer to the maximum transmit power of the terminal.

Manner 2: The transmit power of the first signal is determined based on the power-related information of the downlink signal, that is, the transmit power of the first signal is determined based on path loss measured values of SSB and CSI-RS.

Manner 3: The transmit power of the first signal is determined based on the transmit power of the reference channel (that is, the uplink channel), such as the PUSCH channel, where PUSCH here is a channel of a link from the UE to the BS, and a transmit power of the PUSCH channel is calculated in the following manner:

$${P}_{PUSCH , b , f , c} ( i , j , {q}_{d} , l ) = min \{ \begin{matrix}{P}_{C MAX , f , c} ( i ) , \\ {P}_{O\_PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \}$$

where, a power adjustment amount δ1 is added to the power of P_{PUSCH} to obtain the final first transmit power of the first signal, where δ1 here may be positive, negative, or 0; or the power of P_{PUSCH} is multiplied by the power adjustment factor al to obtain the first transmit power of the final first signal, where α1>0.

Manner 4: The transmit power of the first signal is indicated by the network indication information: (1) semi-static configuration; (2) According to the closed-loop power control principle, the transmit power of the terminal is dynamically controlled by a TPC command; (3) the network-side device adjusts the transmit power of the first signal based on whether a reflected signal of the tag is received. During tag inventory for the terminal, a tag close forms a reflected signal, and a tag far away may not form a reflected signal. Therefore, the network may receive all or part or no reflected signal of the tags. In this case, the network side delivers a first indication to indicate the terminal, telling the terminal whether the network side has received the feedback information of the tags, and/or indicating the terminal whether to increase the transmit power of the first signal. For example, the network is indicated by ACK/NACK. If the first indication is ACK, it indicates that the network receives a feedback of the tag, and the power of the terminal may remain unchanged; for example, the power of the terminal may be gradually reduced. If the first indication is one or more NACK, the transmit power is gradually increased based on a specific step; for example, feedback statuses of a plurality of tags may be indicated to the terminal using the same first indication. The advantage of this example is that in the passive IOT scenario, when a new terminal (UE) is introduced, to determine the transmit power of the first signal between the terminal and the tag, an existing reference channel or signal resource of NR can be used, thus reducing overheads.

According to the power control method in this embodiment of this application, in the BSC system, because the terminal can determine the transmit power of the first signal before transmitting the first signal for BSC, and the transmit power of the signal is positively related to a transmission distance of the signal, the first signal can reach one or some BSC devices, so as to implement power control between the network-side device, the terminal, and the BSC device.

Optionally, in this embodiment of this application, with reference to FIG. 2, as shown in FIG. 5, in a case that the first transmit power is determined based on the network indication information, before the step 201, the power control method provided in this embodiment of this application may further include the following steps 203 and 204.

Step 203: The network-side device transmits network indication information.

Step 204: The terminal receives the network indication information.

It can be understood that the network indication information is used by the terminal to determine the first transmit power of the first signal. For details about other descriptions of step 203 and step 204, refer to the related descriptions in the above embodiments.

Optionally, in this embodiment of this application, in a case that the network indication information includes information determined based on a reception feedback status of the receiving terminal for the second signal, each piece of network indication information indicates a reception feedback status of at least one receiving terminal for the second signal. In other words, the network-side device may use the same network indication information to indicate the reception feedback status of a plurality of terminals for the second signal.

In this embodiment of this application, because each piece of network indication information indicates the reception feedback status of at least one receiving terminal for the second signal, the indication efficiency can be improved.

Optionally, in this embodiment of this application, the above step 203 may be implemented by the following step 203a, and the step 204 may be implemented by the following step 204a.

Step 203a: The network-side device transmits the network indication information through physical downlink control channel (PDCCH) or radio resource control.

Step 204a: The terminal receives the network indication information carried by the PDCCH or RRC.

The target PDCCH is a PDCCH scheduled by the network-side device for the terminal to transmit the first signal.

It can be understood that the network-side device transmits the network indication information through the PDCCH, that is, the network-side device adds the network indication information to the PDCCH and transmits the network indication information.

Optionally, in this embodiment of this application, when the network indication information is TPC information, the TPC information may be carried by the PDCCH. When the network indication information is semi-static configuration information, the semi-static configuration information may be carried by RRC signaling.

In this embodiment of this application, because the network-side device may add the network indication information to the PDCCH that is for scheduling the terminal to transmit the first signal, convenience in transmitting the network indication information by the network-side device can be improved.

In the power control method provided in the embodiments of this application, the execution subject may be a power control apparatus. In the embodiments of this application, the power control method being performed by the power control apparatus is used as an example to describe the power control apparatus provided in the embodiments of this application.

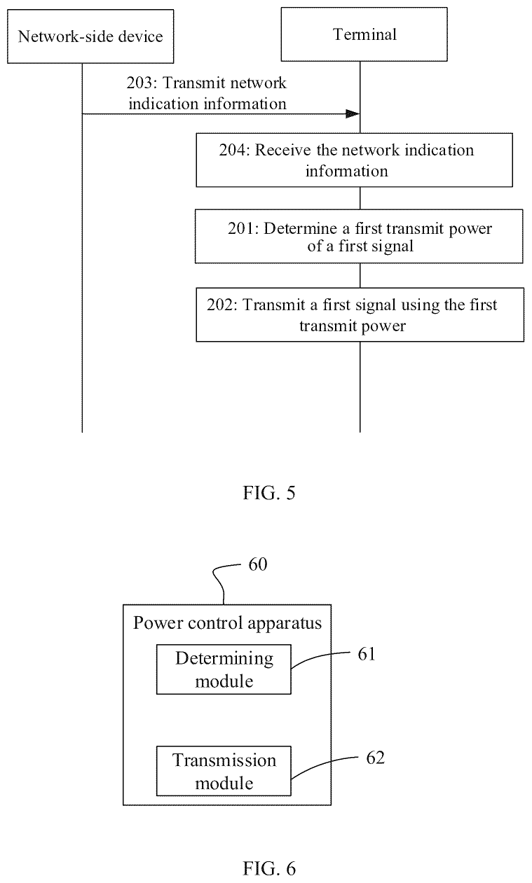

An embodiment of this application further provides a power control apparatus, and FIG. 6 is a possible schematic structural diagram of the power control apparatus provided in this embodiment of this application. As shown in FIG. 6, the power control apparatus 60 provided in this embodiment of this application may include a determining module 61 and a transmission module 62.

The determining module 61 is configured to determine a first transmit power of a first signal, where the first signal is a signal used for BSC.

The transmission module 62 is configured to transmit the first signal using the first transmit power determined by the determining module 61.

In a possible implementation, the first signal includes a carrier signal or a control signal.

In a possible implementation, the first transmit power is determined in at least one of the following manners:
being predefined or pre-configured;
power related information of a downlink signal;
a second transmit power of an uplink channel or an uplink signal;
network indication information; or
a signal type of the first signal; where
the network indication information indicates a transmit power related parameter of the first signal.

In a possible implementation, the downlink signal includes at least one of the following: a downlink reference signal of a serving cell or a downlink reference signal determined based on a BSC-specific reference resource; and
the BSC-specific reference resource is different from a resource of the serving cell.

In a possible implementation, the downlink signal includes at least one of the following: SSB or CSI-RS.

In a possible implementation, the BSC-specific reference resource is determined based on a beacon corresponding to a frequency band supported by the BSC, and the beacon is generated through modulation based on a target modulation mode; and
the beacon includes at least one of the following: one sequence, time synchronization information, or a cell identifier; and the target modulation mode includes at least one of the following: amplitude keying ASK, on-off keying OOK, or phase shift keying PSK.

In a possible implementation, the power-related information of the downlink signal may include at least one of the following: a receive power of the downlink signal or a measured path loss value of the downlink signal.

In a possible implementation, the uplink channel includes at least one of the following: PUSCH, PUCCH, SRS, or PRACH.

In a possible implementation, the first transmit power is determined based on the second transmit power and a power adjustment amount, or the first transmit power is determined based on the second transmit power and a power adjustment factor.

In a possible implementation, the network indication information includes one of the following:
semi-static configuration information, transmit power control TPC information, and information determined by a network-side device based on a reception feedback status of a receiving terminal for a second signal; where

The second signal is a signal for BSC that has been sent by the terminal. The reception feedback status includes at least one of the following: whether the receiving terminal receives the second signal, whether the receiving terminal transmits reception feedback information, or whether the reception feedback information includes adjustment information for adjusting the transmit power of the first signal; where the reception feedback information is feedback information of the receiving terminal on whether the second signal is received.

In a possible implementation, the first transmit power is a power configured using the semi-static configuration information; or the TPC information indicates a transmit power adjustment amount of the first signal and a target power control process for transmitting the first signal by the terminal; where
the target power control process includes one of the following: an independently configured power control process and a power control process same as that of a target channel.

In a possible implementation, the network indication information includes information determined by the network-side device based on the reception feedback status, and the network indication information indicates at least one of the following:
a transmit power adjustment policy of the first signal, or the reception feedback status.

In a possible implementation, in a case that the receiving terminal receives the second signal, the transmit power adjustment policy of the first signal is: not adjusting the transmit power of the first signal, or reducing the transmit power of the first signal; or
in a case that the receiving terminal receives no second signal, the transmit power adjustment policy of the first signal is: increasing the transmit power of the first signal; or
in a case that the reception feedback information includes the transmit power adjustment information, the transmit power adjustment policy of the first signal is: a power adjustment policy indicated by the transmit power adjustment information.

In a possible implementation, the first transmit power is determined based on a signal type of the first signal.

The determining module 61 is configured to determine a transmit power corresponding to the signal type as the first transmit power based on the signal type of the first signal; or adjust a transmit power of a third signal based on the signal type of the first signal, and determine an adjusted transmit power as the first transmit power, where the third signal is a signal for the BSC that has been sent by the transmission module 62.

In a possible implementation, the first transmit power is determined based on the network indication information.

The apparatus further includes a receiving module, where the receiving module is configured to receive the network indication information before the determining module 61 determines the first transmit power of the first signal.

In a possible implementation, the receiving module is configured to receive the network indication information carried by a PDCCH or RRC signaling.

In a possible implementation, the transmission module 62 is configured to transmit the first signal using the first transmit power within at least one first time period after the first transmit power is determined by the determining module 61.

According to the power control apparatus in this embodiment of this application, in the BSC system, because the power control apparatus can determine the transmit power of the first signal before transmitting the first signal for BSC, and the transmit power of the signal is positively related to a transmission distance of the signal, the first signal can reach one or some BSC devices (that is, the receiving terminal), so as to implement communication between the power control apparatus and the BSC device.

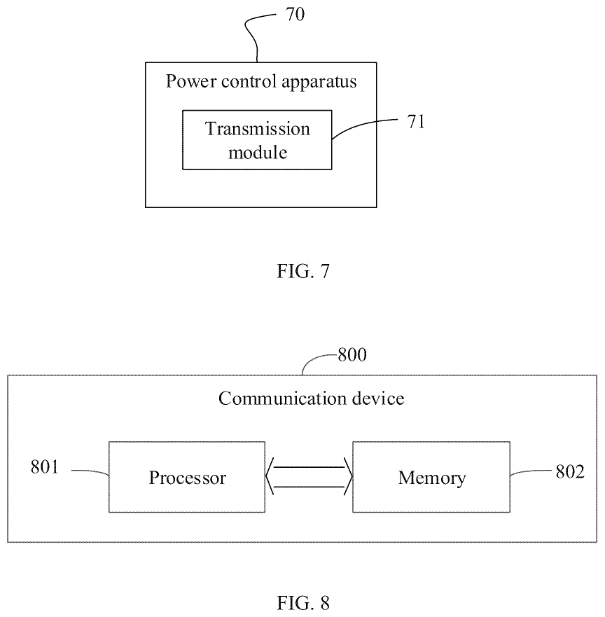

An embodiment of this application further provides a power control apparatus, and FIG. 7 is a possible schematic structural diagram of the power control apparatus provided in this embodiment of this application. As shown in FIG. 7, the power control apparatus 70 provided in this embodiment of this application may include a transmission module 71.

The transmission module 71 is configured to transmit network indication information to a terminal, where the network indication information indicates a transmit power related parameter of a first signal, the first signal is a signal used for BSC, and the network indication information is used by the terminal to determine a first transmit power of the first signal.

In a possible implementation, the network indication information includes any one of the following:
semi-static configuration information, transmit power control TPC information, and information determined based on a reception feedback status of a receiving terminal for a second signal; where
the second signal is a signal for BSC that has been sent by the terminal, and the reception feedback status includes at least one of the following: whether the receiving terminal receives the second signal, whether the receiving terminal transmits reception feedback information, or whether the reception feedback information includes adjustment information for adjusting the transmit power of the first signal; where the reception feedback information is feedback information of the receiving terminal on whether the second signal is received.

In a possible implementation, the first transmit power is a power configured based on the semi-static configuration information; or
the TPC information indicates a transmit power adjustment amount of the first signal and a target power control process for transmitting the first signal by the terminal.

In a possible implementation, the TPC information indicates a transmit power adjustment amount of the first signal.

In a possible implementation, the network indication information includes information determined by the network-side device based on the reception feedback status, and the network indication information indicates at least one of the following:
a transmit power adjustment policy of the first signal, or the reception feedback status.

In a possible implementation, in a case that the receiving terminal receives the second signal, the transmit power adjustment policy of the first signal is: not adjusting the transmit power of the first signal, or reducing the transmit power of the first signal; or in a case that the receiving terminal receives no second signal, the transmit power adjustment policy of the first signal is: increasing the transmit power of the first signal; or in a case that the reception feedback information includes the transmit power adjustment information, the transmit power adjustment policy of the first signal is: a power adjustment policy indicated by the transmit power adjustment information.

In a possible implementation, in a case that the network indication information includes information determined based on a reception feedback status, each piece of network indication information indicates a reception feedback status of a second signal by at least one receiving terminal.

In a possible implementation, the transmission module 71 is configured to transmit the network indication information to the terminal through a PDCCH or RRC signaling.

According to the power control apparatus provided in this embodiment of this application, in the BSC system, because the power control apparatus can transmit the transmit power related parameter of the first signal used for BSC to the terminal, the terminal can determine the first transmit power of the first signal based on the network indication information. In this way, it can be ensured that the first signal can reach one or some BSC devices, so as to implement communication between the terminal and the BSC devices.

The power control apparatus in this embodiment of this application may be an electronic device, such as an electronic device with an operating system, or a component in the electronic device, such as an integrated circuit or a chip. The electronic device may be a terminal or other devices than the terminal. For example, the terminal may include, but is not limited to, the types of the terminal 11 listed above, and other devices may be a server, a network attached storage (NAS), and the like. This is not limited in the embodiment of this application.

The power control apparatus provided in this embodiment of this application can implement the processes implemented in the method embodiment in FIG. 1 to FIG. 5, with the same technical effects achieved. To avoid repetition, details are not described herein again.

Optionally, as shown in FIG. 8, an embodiment of this application further provides a communication device 800, including a processor 801, a memory 802, and a program or instructions stored in the memory 802 and executable on the processor 801. For example, when the communication device 800 is a terminal and when the program or the instructions are executed by the processor 801, the steps of the foregoing embodiments of the power control method are implemented, with the same technical effects achieved. For example, when the communication device 800 is a terminal and when the program or the instructions are executed by the processor 801, the steps of the foregoing method embodiments on the terminal side are implemented, with the same technical effects achieved. To avoid repetition, details are not described herein. Alternatively, when the communication device 800 is a network-side device and when the program or the instructions are executed by the processor 801, the steps of the foregoing method embodiments on the network-side device side are implemented, with the same technical effects achieved. To avoid repetition, details are not described herein.

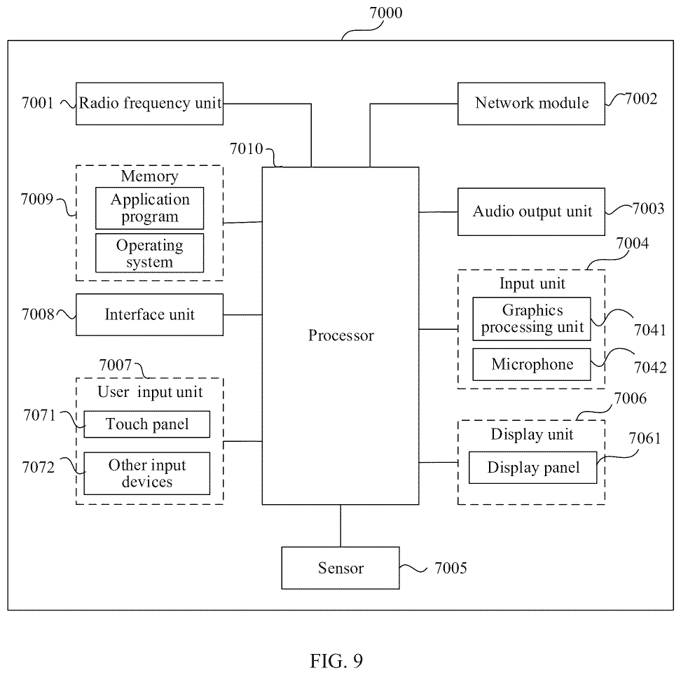

An embodiment of this application further provides a terminal, including a processor and a communication interface, where the processor is configured to determine a first transmit power of a first signal, and the communication interface is configured to transmit the first signal using the first transmit power determined by the processor, where the first signal is a signal used for BSC by the terminal. The terminal embodiments correspond to the foregoing terminal-side method embodiments, and the implementation processes and implementations of the foregoing method embodiments can be applied to the terminal embodiments, with the same technical effects achieved. Optionally, FIG. 9 is a schematic diagram of a hardware structure of a terminal for implementing the embodiments of this application.

As shown in FIG. 9, the terminal 7000 includes but is not limited to components such as a radio frequency unit 7001, a network module 7002, an audio output unit 7003, an input unit 7004, a sensor 7005, a display unit 7006, a user input unit 7007, an interface unit 7008, a memory 7009, and a processor 7010.

Persons skilled in the art can understand that the terminal 7000 may further include a power supply (for example, a battery) supplying power to the components, and the power supply may be logically connected to the processor 7010 through a power management system. In this way, functions such as charge management, discharge management, and power consumption management are implemented by using the power management system. The structure of the terminal shown in FIG. 9 does not constitute any limitation on the terminal. The terminal may include more or fewer components than shown in the figure, or a combination of some components, or the components disposed differently. Details are not described herein again.

It can be understood that in this embodiment of this application, the input unit 7004 may include a graphics processing unit (GPU) 7041 and a microphone 7042. The graphics processing unit 7041 processes image data of a still picture or video obtained by an image capture apparatus (such as a camera) in a video capture mode or an image capture mode. The display unit 7006 may include a display panel 7061, and the display panel 7061 may be configured in a form of a liquid crystal display, an organic light-emitting diode, and the like. The user input unit 7007 may include at least one of a touch panel 7071 and other input devices 7072. The touch panel 7071 is also referred to as a touchscreen. The touch panel 7071 may include two parts: a touch detection apparatus and a touch controller. The other input devices 7072 may include but are not limited to a physical keyboard, a function key (such as a volume control key or a power on/off key), a trackball, a mouse, a joystick, and the like. Details are not described herein.

In this embodiment of this application, the radio frequency unit 7001 receives downlink data from a network-side device, and then sends the downlink data to the processor 7010 for processing. In addition, the radio frequency unit 7001 may sends uplink data to the network-side device. Generally, the radio frequency unit 7001 includes but is not limited to an antenna, an amplifier, a transceiver, a coupler, a low noise amplifier, a duplexer, and the like.

The memory 7009 may be configured to store software programs or instructions and various data. The memory 7009 may include a first storage area for storing a program or instructions and a second storage area for storing data. The first storage area may store an operating system, an application program or instruction required by at least one function (for example, a sound playback function or an image playback function), and the like. In addition, the memory 7009 may include a volatile memory or a non-volatile memory, or the memory 7009 may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory can be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchlink dynamic random access memory (SLDRAM), and a direct rambus random access memory (DRRAM). The memory 709 in the embodiments of this application includes but is not limited to these and any other suitable types of memories.

The processor 7010 may include one or more processing units. Optionally, an application processor and a modem processor may be integrated in the processor 7010. The application processor primarily processes operations involving an operating system, user interfaces, application programs, and the like. The modem processor primarily processes radio communication signals, for example, being a baseband processor. It can be understood that the modem processor may alternatively be not integrated in the processor 7010.

The processor 7010 may be configured to determine a first transmit power of a first signal, where the first signal is a signal used for BSC; and the radio frequency unit 7001 is configured to transmit the first signal using the first transmit power.

The terminal provided in this embodiment of this application is capable of implementing the processes implemented by the terminal in the method embodiment, with the same technical effects achieved. To avoid repetition, details are not described herein again.

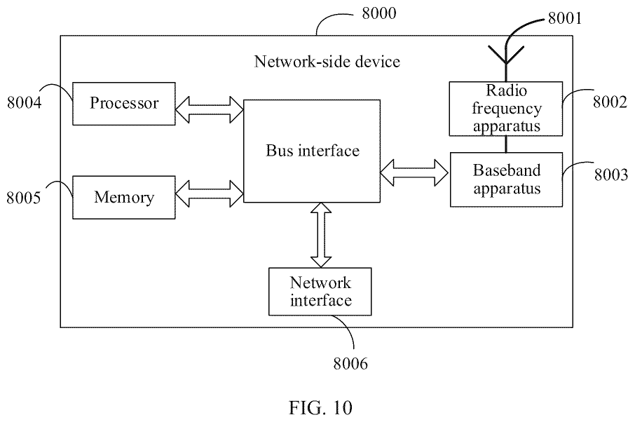

An embodiment of this application further provides a network-side device, including a processor and a communication interface, where the communication interface is configured to transmit network indication information to a terminal, where the network indication information indicates a transmit power related parameter of a first signal, the first signal is a signal used for BSC, and the network indication information is used by the terminal to determine a first transmit power of the first signal. The network-side device embodiments correspond to the foregoing network-side device method embodiments, and the implementation processes and implementations of the foregoing method embodiments can be applied to the network-side device embodiments, with the same technical effects achieved. Optionally, FIG. 10 is a schematic diagram of a hardware structure of a network-side device for implementing the embodiments of this application.

Optionally, an embodiment of this application further provides a network-side device. As shown in FIG. 10, the network-side device 8000 includes an antenna 8001, a radio frequency apparatus 8002, a baseband apparatus 8003, a processor 8004, and a memory 8005. The antenna 8001 is connected to the radio frequency apparatus 8002. In an uplink direction, the radio frequency apparatus 8002 receives information by using the antenna 8001, and sends the received information to the baseband apparatus 8003 for processing. In a downlink direction, the baseband apparatus 8003 processes to-be-sent information, and sends the information to the radio frequency apparatus 8002; and the radio frequency apparatus 8002 processes the received information and then sends the information out by using the antenna 8001.

The radio frequency apparatus 8002 is configured to transmit network indication information to a terminal, where the network indication information indicates a transmit power related parameter of a first signal, the first signal is a signal used for BSC, and the network indication information is used by the terminal to determine a first transmit power of the first signal.

The terminal provided in this embodiment of this application is capable of implementing the processes implemented by the network-side device in the method embodiment, with the same technical effects achieved. To avoid repetition, details are not described herein again.

The method executed by the network-side device in the foregoing embodiments can be implemented in the baseband apparatus 8003, and the baseband apparatus 8003 includes a baseband processor.

The baseband apparatus 8003 may include, for example, at least one baseband board, where a plurality of chips are disposed on the baseband board. As shown in FIG. 10, one of the chips is, for example, a baseband processor, and is connected to the memory 8005 through the bus interface, to invoke a program in the memory 8005 to perform the operations of the first network-side device or the second network-side device shown in the foregoing method embodiments.

The network-side device may further include network interface 8006, where the interface is, for example, a common public radio interface (CPRI).

Optionally, the network-side device 8000 in this embodiment of the present application further includes: instructions or a program stored in the memory 8005 and executable on the processor 8004. The processor 8004 invokes the instructions or program in the memory 8005 to execute the method executed by the foregoing modules, with the same technical effects achieved. To avoid repetition, details are not repeated herein.

An embodiment of this application further provides a non-transitory readable storage medium, where a program or instructions are stored in the non-transitory readable storage medium. When the program or the instructions are executed by a processor, the processes of the foregoing embodiment of the power control method can be implemented, with the same technical effects achieved. To avoid repetition, details are not described herein again.

The processor is a processor in the terminal described in the foregoing embodiments. The non-transitory readable storage medium includes a non-transitory computer-readable storage medium, for example, a computer read only memory ROM, a random access memory RAM, a magnetic disk, or an optical disc.

An embodiment of this application further provides a chip, where the chip includes a processor and a communication interface. The communication interface is coupled to the processor, and the processor is configured to run a program or instructions to implement the processes of the foregoing power control method embodiments, with the same technical effects achieved. To avoid repetition, details are not described herein again.

It should be understood that the chip mentioned in the embodiments of this application may also be referred to as a system-level chip, a system chip, a chip system, a system-on-chip, or the like.

An embodiment of this application further provides a computer program/program product, where the computer program/program product is stored in a non-transitory storage medium, and when being executed by at least one processor, the computer program/program product is configured to implement the processes of the foregoing power control method embodiments, with the same technical effects achieved. To avoid repetition, details are not repeated herein.

An embodiment of this application further provides a communication system, including a terminal and a network-side device, where the terminal can be configured to execute the processes of the foregoing embodiments of the power control method on the terminal side, and the network-side device can be configured to execute the processes of foregoing embodiments of the power control method on the network-side device side.

It should be noted that in this specification, the term “include”, “comprise”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. It should be noted that the scope of the methods and apparatuses in the embodiments of this application is not limited to performing the functions in the order shown or discussed, but may also include performing the functions in a substantially simultaneous manner or in a reverse order depending on the functions involved. For example, the described method may be performed in an order different from the order described, and steps may be added, omitted, or combined. In addition, features described with reference to some examples may be combined in other examples.

According to the description of the foregoing implementations, persons skilled in the art can clearly understand that the method in the foregoing embodiments may be implemented by software in combination with a necessary general hardware platform. Certainly, the method in the foregoing embodiments may alternatively be implemented by hardware. Based on such an understanding, the technical solutions of this application essentially or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, a network device, or the like) to perform the methods described in the embodiments of this application.

The foregoing describes the embodiments of this application with reference to the accompanying drawings. However, this application is not limited to the foregoing implementations. These implementations are merely illustrative rather than restrictive. Inspired by this application, persons of ordinary skill in the art may develop many other forms without departing from the essence of this application and the protection scope of the claims, and all such forms shall fall within the protection scope of this application.

What is claimed is:

1. A power control method, comprising:
determining, by a terminal, a first transmit power of a first signal, wherein the first signal is a signal used for backscatter communication (BSC); and
transmitting, by the terminal, the first signal using the first transmit power.

2. The method according to claim 1, wherein the first signal comprises a carrier signal or a control signal.

3. The method according to claim 1, wherein the first transmit power is determined in at least one of the following manners:
being predefined or pre-configured;
power related information of a downlink signal;
a second transmit power of an uplink channel or an uplink signal;
network indication information; or
a signal type of the first signal; wherein
the network indication information indicates a transmit power related parameter of the first signal.

4. The method according to claim 3, wherein the downlink signal comprises at least one of the following: a downlink reference signal of a serving cell or a downlink reference signal determined based on a BSC-specific reference resource; and
the BSC-specific reference resource is different from a resource of the serving cell;
or,
the downlink signal comprises at least one of the following:
a synchronization signal block (SSB) or a channel state information reference signal (CSI-RS);
or,
the power related information comprises at least one of the following: a receive power of the downlink signal or a measured path loss value of the downlink signal;
or,
the uplink channel comprises at least one of the following: an physical uplink shared channel (PUSCH), a physical uplink control channel (PUCCH), an uplink sounding reference signal (SRS), or a physical random access channel (PRACH).

5. The method according to claim 4, wherein the BSC-specific reference resource is determined based on a beacon corresponding to a frequency band supported by the BSC, and the beacon is generated through modulation based on a target modulation mode; and
the beacon comprises at least one of the following: one sequence, time synchronization information, or a cell identifier; and the target modulation mode comprises at least one of the following: amplitude keying (ASK), on-off keying (OOK), or phase shift keying (PSK).

6. The method according to claim 3, wherein the first transmit power is determined based on the second transmit power and a power adjustment amount, or the first transmit power is determined based on the second transmit power and a power adjustment factor.

7. The method according to claim 3, wherein the network indication information comprises one of the following:
semi-static configuration information, transmit power control (TPC) information, and information determined by a network-side device based on a reception feedback status of a receiving terminal for a second signal; wherein
the second signal is a signal for the BSC that has been sent by the terminal; and
the reception feedback status comprises at least one of the following: whether the receiving terminal receives the second signal, whether the receiving terminal transmits reception feedback information, or whether the reception feedback information comprises adjustment information for adjusting a transmit power of the first signal; and the reception feedback information is feedback information of the receiving terminal on whether the second signal is received.

8. The method according to claim 7, wherein the TPC information indicates a transmit power adjustment amount of the first signal; or
the TPC information indicates a transmit power adjustment amount of the first signal and a target power control process for transmitting the first signal by the terminal; wherein
the target power control process comprises one of the following: an independently configured power control process and a same power control process as a target channel;
or,
the network indication information comprises information determined by the network-side device based on the reception feedback status, and the network indication information indicates at least one of the following:
a transmit power adjustment policy of the first signal, or the reception feedback status.

9. The method according to claim 7, wherein in a case that the receiving terminal receives the second signal, a transmit power adjustment policy of the first signal is: not adjusting the transmit power of the first signal, or reducing the transmit power of the first signal; or
in a case that the receiving terminal receives no second signal, the transmit power adjustment policy of the first signal is: increasing the transmit power of the first signal; or
in a case that the reception feedback information comprises transmit power adjustment information, the transmit power adjustment policy of the first signal is: a power adjustment policy indicated by the transmit power adjustment information.

10. The method according to claim 3, wherein the first transmit power is determined based on the signal type of the first signal; and
the determining, by a terminal, a first transmit power of a first signal comprises:
determining, by the terminal, a transmit power corresponding to the signal type as the first transmit power based on the signal type of the first signal; or
adjusting, by the terminal, a transmit power of a third signal based on the signal type of the first signal, and determining an adjusted transmit power as the first transmit power, wherein the third signal is a signal for the BSC that has been sent by the terminal.

11. The method according to claim 3, wherein the first transmit power is determined based on the network indication information; and
before the determining, by a terminal, a first transmit power of a first signal, the method further comprises:
receiving, by the terminal, the network indication information; wherein
the receiving, by the terminal, the network indication information comprises:
receiving, by the terminal, the network indication information carried by a physical downlink control channel (PDCCH) or radio resource control (RRC) signaling.

12. The method according to claim 1, wherein the transmitting, by the terminal, the first signal using the first transmit power comprises:
transmitting, by the terminal, the first signal using the first transmit power within at least one first time period after the first transmit power is determined.

13. A power control method, comprising:
transmitting, by a network-side device, network indication information to a terminal, wherein the network indication information indicates a transmit power related parameter of a first signal, the first signal is a signal used for backscatter communication (BSC), and the network indication information is used by the terminal to determine a first transmit power of the first signal.

14. The method according to claim 13, wherein the network indication information comprises any one of the following:
semi-static configuration information, transmit power control (TPC) information, and information determined based on a reception feedback status of a receiving terminal for a second signal; wherein
the second signal is a signal for the BSC that has been sent by the terminal, the reception feedback status comprises at least one of the following: whether the receiving terminal receives the second signal, whether the receiving terminal transmits reception feedback information, or whether the reception feedback information comprises adjustment information for adjusting a transmit power of the first signal; and the reception feedback information is feedback information of the receiving terminal on whether the second signal is received.

15. The method according to claim 14, wherein the TPC information indicates a transmit power adjustment amount of the first signal; or
the TPC information indicates a transmit power adjustment amount of the first signal and a target power control process for transmitting the first signal by the terminal;
or,
the network indication information comprises information determined by the network-side device based on the reception feedback status, and the network indication information indicates at least one of the following:
a transmit power adjustment policy of the first signal, or the reception feedback status.

16. The method according to claim 14, wherein in a case that the receiving terminal receives the second signal, a transmit power adjustment policy of the first signal is: not adjusting the transmit power of the first signal, or reducing the transmit power of the first signal; or
in a case that the receiving terminal receives no second signal, the transmit power adjustment policy of the first signal is: increasing the transmit power of the first signal; or
in a case that the reception feedback information comprises transmit power adjustment information, the transmit power adjustment policy of the first signal is: a power adjustment policy indicated by the transmit power adjustment information.

17. The method according to claim 14, wherein in a case that the network indication information comprises the information determined based on the reception feedback status, each piece of the network indication information indicates a reception feedback status of at least one receiving terminal for the second signal.

18. The method according to claim 13, wherein the transmitting, by a network-side device, network indication information to a terminal comprises:
sending, by the network-side device, the network indication information to the terminal through a physical downlink control channel (PDCCH) or radio resource control (RRC) signaling.

19. A terminal, comprising a processor and a memory, wherein a program or instructions executable on the processor are stored in the memory, and the program or the instructions, when executed by the processor, cause the terminal to perform:
determining a first transmit power of a first signal, wherein the first signal is a signal used for backscatter communication (BSC); and
transmitting the first signal using the first transmit power.

20. A network-side device, comprising a processor and a memory, wherein a program or instructions executable on the processor are stored in the memory, and when the program or the instructions are executed by the processor, steps of the power control method according to claim 13 are implemented.
